(19) United States
(12) Patent Application Publication
(10) Pub. No.: US 2007/0093992 A1
(43) Pub. Date: Apr. 26, 2007

(54) Data processing apparatus

(75) Inventor: Yasuhiro Yoshino, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/526,644

(22) Filed: Sep. 26, 2006

(30) Foreign Application Priority Data
Sep. 29, 2005 (JP) 2005-284065

(51) Int. Cl. H04B 15/00

(52) U.S. Cl. 702/199

(57) ABSTRACT

A data processing apparatus, includes: a first storage unit which comprises a plurality of memory blocks separated corresponding to predetermined number of data and sequentially stores a plurality of time series measurement data; a block operation unit which performs an operation for the measurement data stored in the memory blocks of the first storage unit for each memory block to calculate block operation values; a second storage unit which stores the block operation values calculated by the block operation unit; and a moving average calculation unit which calculates a moving average of the measurement data based on the block operation values stored in the second storage unit.

### BACKGROUND OF THE INVENTION

1. Field of the Invention

The present invention relates to a data processing apparatus which calculates a moving average based on measurement values.

2. Description of the Related Art

Conventionally, there are some conventional data processing apparatuses for calculating a moving average of measurement values. Such a moving average is calculated as an average of measurement values measured during a predetermined period. In observation of a time series of measurement values by such a data processing apparatus, it is possible to facilitate reading the basic tendency of the measurement values by referring to the moving average in which an irregular fluctuation that the measurement values widely fluctuates due to a special factor or the like, is reduced to some extent.

FIG. 1A shows a functional configuration of a measurement apparatus 20 which is a conventional data processing apparatus and calculates the moving average. As shown in FIG. 1A, the measurement apparatus 20 includes a control circuit 21 which has a central processing unit (CPU), a read only memory (ROM), a random access memory (RAM) and an oscillator for generating a clock signal, which are not particularly shown and which controls an overall operation of the measurement apparatus 20 in synchronization with the clock signal; a measurement circuit 22 which converts analogue signals outputted from a not particularly shown sensor into digital signals and outputs the digital signals as measurement values in response to an instruction of the control circuit 21; a static random access memory (SRAM) 23 which sequentially stores the measurement values; and a moving average calculation circuit 24 which calculates the moving average from the measurement values. Each section is electrically connected to the other sections.

FIG. 1B is a view showing an example of calculation of the moving average in the measurement apparatus 20. As shown in FIG. 1B, the moving average in the measurement apparatus 20 is an arithmetic average of the sum of measurement values within a predetermined period of time with respect to the number of the measurements based on the measurement values A to E measured at times T1 to T5.

As shown in FIG. 1B, the SRAM 23 is configured to store the measurement values of the number of the averages in the predetermined period of time into a ring buffer in order to calculate the moving average. For example, at the time T5, the measurement value A which is an old measurement value not within the predetermined period of time is overwritten with the measurement value E measured at the time T5. At the time T5, the moving average is calculated based on the measurement values B to E stored in the SRAM 23. The measurement apparatus 20 can calculate the moving average with the aforementioned configuration.

The technology concerning the aforementioned data processing apparatus which calculates the moving average is also shown in Patent Literature 1 as a frequency variation measurement apparatus which calculates the moving average in the following manner. Last n measurement values starting from the previous measurement value are stored, and the n-th previous measurement value is subtracted from the current measurement value. Such a difference is sequentially added and accumulated, and the accumulated value is divided by n, thus calculating the moving average.

Patent Literature 1: Japanese Patent Laid-open publication No. 7-55554

However, when the period of time to calculate the moving average is long and the number of the averages is large, it is required to ensure many storage areas for storing the measurement values during the above period of time. Therefore, the cost thereof became high.

### SUMMAY OF THE INVENTION

The present invention was made in the light of such a problem, and an object of the present invention is to provide a data processing apparatus for calculating a moving average at a lower cost.

In order to solve the aforementioned problem, in accordance with a first aspect of the present invention, a data processing apparatus, comprising:

a first storage unit which comprises a plurality of memory blocks separated corresponding to predetermined number of data and sequentially stores a plurality of time series measurement data;

a block operation unit which performs an operation for the measurement data stored in the memory blocks of the first storage unit for each memory block to calculate block operation values;

a second storage unit which stores the block operation values calculated by the block operation unit; and

a moving average calculation unit which calculates a moving average of the measurement data based on the block operation values stored in the second storage unit.

According to the first aspect of the present invention, the plurality of time series measurement data are stored in the first storage unit previously separated into blocks corresponding to the predetermined number of data, and the block operation values obtained by performing an operation for the measurement data for each block, which is stored in each of the memory blocks are stored in the second storage unit. The moving average of the measurement data is calculated based on the block operation value. This eliminates the need to store all the measurement data necessary for calculation of the moving average. Even in the case of calculating the moving average from many measurement data, therefore, the calculation can be carried out with a less storage source, thus keeping the cost down.

Preferably, the first storage unit is DRAM and the second storage unit is SRAM.

In the present invention, the first and second storage units are DRAM and SRAM, respectively. Accordingly, even when the power supply to the first and second storage units is stopped in the middle of measurement, the block operation values of the measurement data stored in the second storage unit are not erased, so that an error in calculating the moving average can be small. Moreover, even when more measurement data which are used before the calculation of the block operation value, is stored, the cost can be kept down.

Preferably, each of the block operation values is a block sum of the measurement data stored in each of the memory blocks.

In the present invention, the moving average can be calculated based on the block sums of the measurement data stored in the individual memory blocks.

Preferably, each of the block operation values is a block average of the measurement data stored in each of the memory blocks.

In the present invention, the moving average can be calculated based on the block averages of the measurement data stored in the individual memory blocks.

Preferably, the data processing apparatus according to the fourth aspect further comprises: a controller which transfers and stores the block averages stored in the second storage unit into the first storage unit after a power supply recovers.

In the present invention, the data processing apparatus further includes the controller which stores the block averages of the measurement data stored in the second storage unit into the first storage unit after the power supply recovers. Accordingly, when the power supply recovers, the moving average can be calculated based on the block operation values before the power supply is stopped.

### BRIEF DESCRIPTION OF THE DRAWINGS

The present invention will become fully understood from the detailed description given hereinafter and the accompanying drawings given by way of illustration only, and thus are not intended as a definition of the limits of the present invention, wherein:

FIG. 1A is a schematic diagram showing a functional configuration of a conventional measurement apparatus 20;

FIG. 1B is a schematic view showing calculation of moving averages;

FIG. 2 is a schematic diagram showing a functional configuration of a data processing apparatus 10 according to the present invention;

FIG. 3 is a flowchart showing an operation of calculating block operation values, which is performed by a controlling each section in the data processing apparatus 10 with controller 11;

FIG. 4A is a view schematically showing an example of a way to store measurement values in a first storage unit 13; and

FIG. 4B is a view schematically showing an example of a way to store values stored in a second storage unit 15 into the first storage unit 13.

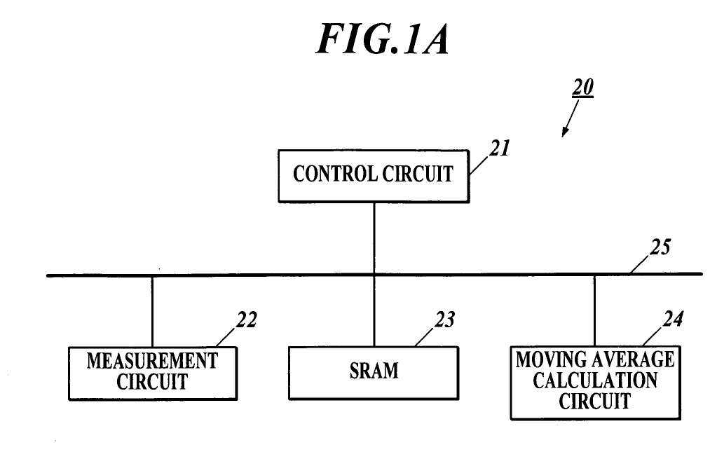

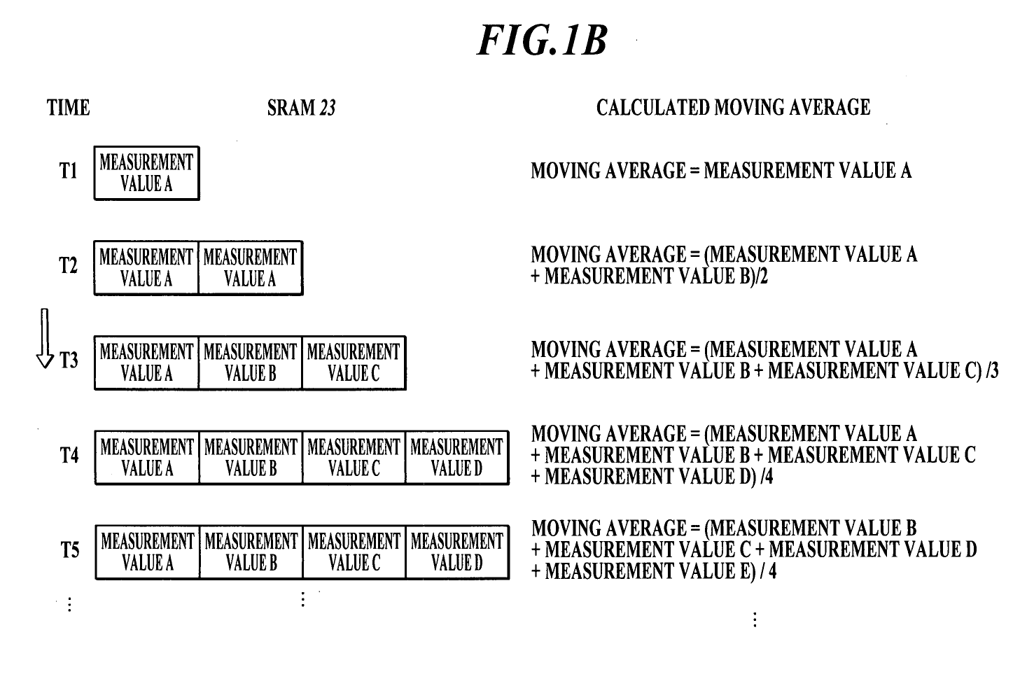

### DETAILED DESCRIPTION OF THE PREFERRED EMBODIMENT

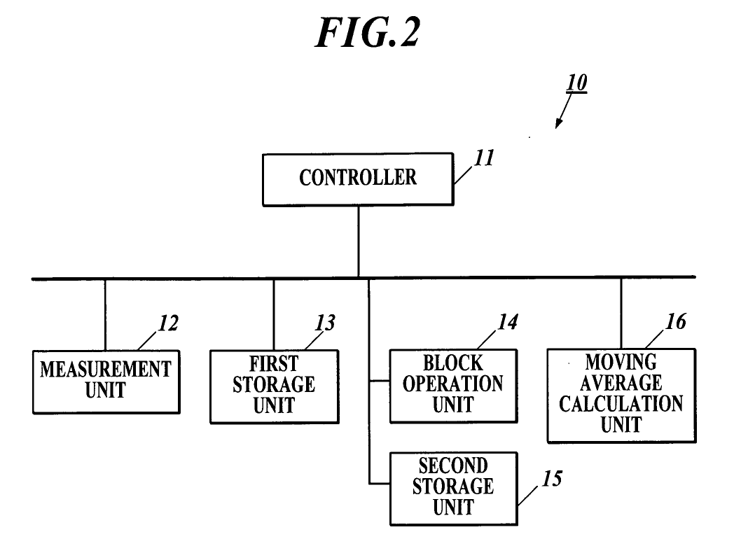

Hereinafter, a description is given of an embodiment of the present invention in detail with reference to FIGS. 2 to 4B, but the present invention is not limited to this embodiment. Moreover, the embodiment of the present invention shows the most preferable mode of the present invention, and terms or applications of the present invention are not limited to this.

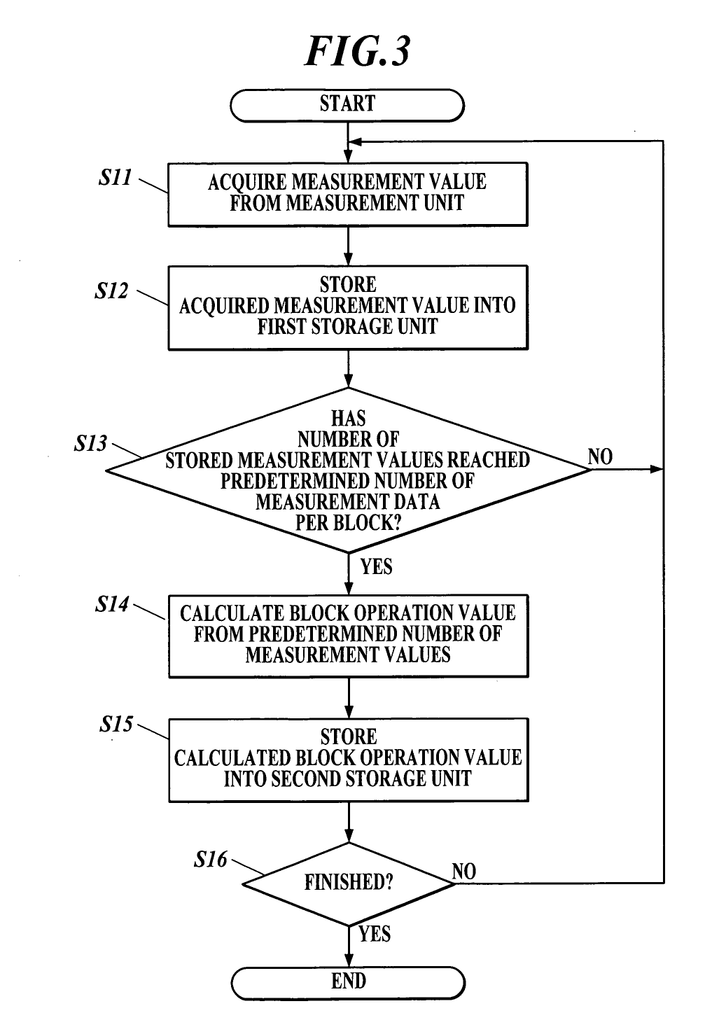

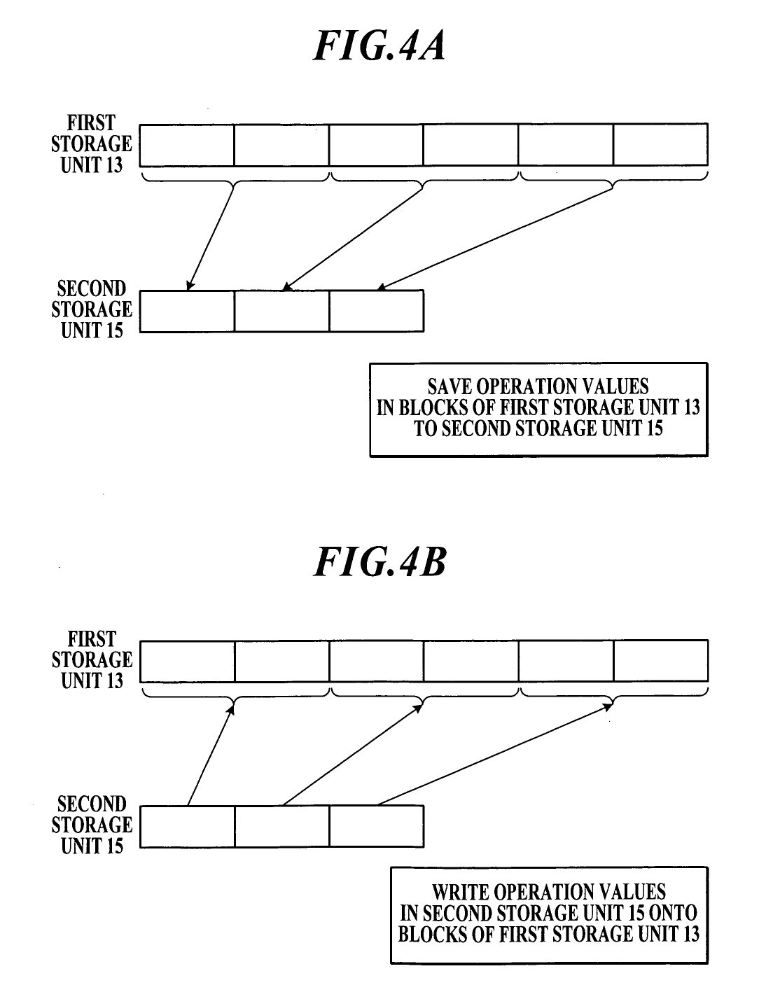

FIG. 2 is a schematic diagram showing a functional configuration of a data processing apparatus 10, and FIG. 3 is a flowchart showing an operation of calculating block operation values, which is performed by a controller 11 controlling each component in the data processing apparatus 10. FIG. 4A is a view schematically showing an example of a way to store measurement values into a first storage unit 13, and FIG. 4B is a view schematically showing an example of a way to store values stored in a second storage unit 15 into the first storage unit 13.

First, a description is given of a configuration of the data processing apparatus 10. As shown in FIG. 2, the data processing apparatus 10 includes the controller 11, a measurement unit 12, a first storage unit 13, a block operation unit 14, a second storage unit 15, and a moving average calculation unit 16.

The controller 11 is a circuit including a CPU, a ROM, a RAM, an oscillator, and the like. The CPU reads control programs and setting values stored in the ROM and sequentially executes the programs by using a work area set to a predetermined area of the RAM. The controller 11 thus controls an overall operation of the data processing apparatus 10.

Specifically, the controller 11 acquires measurement values (measurement data) measured in a time series by the measurement unit 12 in synchronization with a clock signal generated by the oscillator and stores the measurement values in the first storage unit 13. The controller 11 then executes a later-described process to calculate block operation values and stores results of the calculation in the second storage unit 15. Moreover, in response to an instruction by an operation key which is not particularly shown, to output the moving average, the controller 11 transfers the data stored in the second storage unit 15 to the moving average calculation unit 16 to output the moving average.

The measurement unit 12 is a circuit which converts analog signals outputted from a variety of sensors into digital signals and outputs the digital signals as measurement values. The measurement unit 12 outputs the measurement values in synchronization with the clock signal generated by the controller 11.

The first storage unit 13 is a dynamic random access memory (DRAM) or the like which stores charges by a capacitor and a transistor and is readable and writable. The first storage unit 13 sequentially stores the measurement values measured by the measurement unit 12 for each block corresponding to the number of data previously set by information stored in the ROM of the controller 11 or by an operational instruction from an operation section not particularly shown, such as an operation key or a pointing device.

In the case where the first storage unit 13 comprises a DRAM, the stored charges decrease with time, and accordingly the rewriting (refresh) for holding memory is performed each certain period of time by an instruction of the controller 11. In the first storage unit 13, stored information is therefore erased when the apparatus is powered off. However, unlike SRAM which holds stored information by a flip-flip circuit, the degree of the integration of the storage unit can be increased at a low cost.

The block operation unit 14 performs an operation for the aforementioned measurement values sequentially stored in the blocks in the first storage unit 13 to calculate block operation values. Specifically, the calculation of the block sums which are sums of the measurement values sequentially stored in the blocks or calculation of block averages which are averages of the measurement values sequentially stored in the blocks is performed for each block.

The second storage unit 15 is SRAM in which the stored information is held without being refreshed and stores the block operation values calculated by the block operation unit 14. Accordingly, even when the apparatus is powered off, the stored block operation values can be held. The moving average based on the stored block operation values can be therefore calculated when the apparatus is powered on again.

The moving average calculation unit 16 calculates the moving average for a predetermined period of time (of the predetermined number of blocks) based on the block operation values stored in the second storage unit 15. The moving average is calculated in the moving average calculation unit 16 as an arithmetic average of the block operation values of the individual blocks similar to the moving average in the above-described measurement apparatus 20. When the block operation values are the block average, such calculation is performed in such a way that the sum of the block averages is divided by the number of blocks concerning the calculation or a way that a value obtained by subtracting the oldest block average from the sum of the block averages calculated at the previous operation and adding the latest block average thereto is divided by the number of blocks concerning the calculation.

When the block operation values are block sums, similarly, the calculation is performed in such a way that the total value of the block sums is divided by a product of the number of blocks concerning the calculation and the number of data of each block or in such a way that a value obtained by subtracting the oldest block sum from the total value of the block sums calculated at the previous operation is divided by a product of the number of blocks concerning the calculation and the number of data of each block.

The moving average calculated by the moving average calculation unit 16 may be, in addition to the aforementioned simple moving average, a weighted moving average calculated by weighting a later measurement value more heavily, an exponential moving average, or the like, and is not particularly limited.

Next, a description is given of an operation of the controller 11 calculating the block operation value of each block based on the measurement values stored in the first storage unit 13. As shown in FIG. 3, the controller unit 11 acquires a measurement value from the measurement unit 12 (step S11) and stores the acquired measurement value in the first storage unit (step S12).

Subsequently, it is judged whether the number of the measurement values stored in the first storage unit 13 has reached the predetermined number of data per block (step S13), and when the number of the measurement values has not reached the predetermined number, the operation returns to the step S11.

In the step S13, when the number of the measurement values has reached the predetermined number, in the block operation unit 14, the block operation value is calculated based on the measurement values of the predetermined number of data per block (step S14). The calculated block operation value is stored in the second storage unit 15 (step S15), and the presence of an instruction by the not-shown operation key to finish the measurement or the end of a previously instructed measurement time is judged to determine whether to finish the measurement (step S16). When the measurement is determined to be continued, the operation returns to the step S11, and when the measurement is determined to be finished, the operation is ended.

As described above, the data processing apparatus 10 has a configuration to calculate the block operation values for the individual blocks based on the measurement values. As shown in FIG. 4A, the block operation values of the measurement values stored in the first storage unit 13 are calculated and stored in the second storage unit 15. Accordingly, the apparatus 10 requires a less memory source to store information necessary for calculating the moving average in the moving average calculation unit 16. Even when the moving average is calculated from many measurement values, the apparatus 10 can be implemented at low cost.

Moreover, the data processing apparatus 10 has a configuration in which the second storage unit 15 is an SRAM. Accordingly, even when the apparatus is powered off in the middle of measurement and powered on again for measurement, the moving average can be calculated from the block operation values stored in the SRAM.

In the data processing apparatus 10, the first storage unit which stores the measurement values before the block operation values are calculated, is a DRAM, thus increasing the degree of integration of a section temporarily storing information at lower cost.

Moreover, the data processing apparatus 10 can calculate the moving average based on the block averages or block sums which are the block operation values.

The processing apparatus 10 may be configured as follows. In the step S13, an instruction by a power key or the like to shut off the power supply is detected, and in the case of shutting off the power supply, the block operation values are calculated based on the measurement values stored in the first storage unit 13 in the block operation unit 14 (step S14). The calculated block operation values are then stored in the second storage unit 15, and the operation is finished. In this case, even when the power supply is stopped in the middle of the measurement, the measurement data which is related to the moving average and stored in the first storage unit 13 can be saved in the second storage unit 15 which holds records independently of the presence of the power supply.

Furthermore, when the power supply is recovered, as shown in FIG. 4B, the block averages stored in the second storage unit 15 may be returned to the first storage unit 13. In this case, the moving average based on the previous block operation values can be calculated when the power supply is recovered.

The description of the embodiment shows an example of the present invention and does not limit the present invention. The detailed configuration and operation of the data processing apparatus 10 of the present invention can be properly modified without departing from the scope of the present invention. For example, the data processing apparatus 10 includes the measurement unit 12. However, the data processing apparatus 10 may be configured to receive measurement data transmitted from an external measurement apparatus.

The entire disclosure of Japanese Patent Application No. Tokugan 2005-284065 which was filed on Sep. 29, 2005 including specification, claims, drawings and summary are incorporated herein by reference in its entirety.

What is claimed is:

1. A data processing apparatus, comprising:
a first storage unit which comprises a plurality of memory blocks separated corresponding to predetermined number of data and sequentially stores a plurality of time series measurement data;
a block operation unit which performs an operation for the measurement data stored in the memory blocks of the first storage unit for each memory block to calculate block operation values;
a second storage unit which stores the block operation values calculated by the block operation unit; and
a moving average calculation unit which calculates a moving average of the measurement data based on the block operation values stored in the second storage unit.

2. The data processing apparatus as claimed in claim 1, wherein
the first storage unit is DRAM, and the second storage unit is SRAM.

3. The data processing apparatus as claimed in claim 1, wherein
each of the block operation values is a block sum of the measurement data stored in each of the memory blocks.

4. The data processing apparatus as claimed in claim 1, wherein
each of the block operation values is a block average of the measurement data stored in each of the memory blocks.

5. The data processing apparatus as claimed in claim 4, further comprising:
a controller which transfers and stores the block averages stored in the second storage unit into the first storage unit after a power supply recovers.

6. The data processing apparatus as claimed in claim 2, wherein
each of the block operation values is a block sum of the measurement data stored in each of the memory blocks.

7. The data processing apparatus as claimed in claim 2, wherein
each of the block operation values is a block average of the measurement data stored in each of the memory blocks.

8. The data processing apparatus as claimed in claim 7, further comprising:
a controller which transfers and stores the block averages stored in the second storage unit into the first storage unit after a power supply recovers.
